(19) United States
(12) Patent Application Publication
(10) Pub. No.: US 2016/0065760 A1
(43) Pub. Date: Mar. 3, 2016

(54) INFORMATION PROCESSING APPARATUS, METHOD FOR PROCESSING INFORMATION, AND INFORMATION PROCESSING SYSTEM

(71) Applicant: Takahiro ASO, Tokyo (JP)

(72) Inventor: Takahiro ASO, Tokyo (JP)

(21) Appl. No.: 14/834,658

(22) Filed: Aug. 25, 2015

(30) Foreign Application Priority Data
Aug. 28, 2014 (JP) 2014-174430

(51) Int. Cl. H04N 1/00; G06Q 30/02; H04N 1/44

(52) U.S. Cl. CPC H04N 1/00342; H04N 1/4426; H04N 1/00506; H04N 1/00129; G06Q 30/0271; H04N 2201/0094

(57) ABSTRACT

An information processing apparatus connected to a managing apparatus that manages display information via a network, the information processing apparatus comprises: a communication unit that transmits apparatus identification information and apparatus information to the managing apparatus and receives the display information and the apparatus information from the managing apparatus; a reading unit that reads user identification information from a storage medium; an authenticating unit that authenticates a user by the user identification information; a display controller that, when the user is authenticated, displays publicly-available first display information among the received display information on a display unit; and a determining unit that determines whether the storage medium is within a certain distance, wherein the display controller, when the storage medium is determined to be present within the certain distance, displays, on the display unit, second display information available to a specific user including an authenticated user among the received display information.

### CROSS-REFERENCE TO RELATED APPLICATIONS

The present application claims priority to and incorporates by reference the entire contents of Japanese Patent Application No. 2014-174430 filed in Japan on Aug. 28, 2014.

### BACKGROUND OF THE INVENTION

1. Field of the Invention

The present invention relates to an information processing apparatus, a method for processing information, and an information processing system.

2. Description of the Related Art

A technique has been known that acquires identification information from a user to authenticate the user and displays display information such as advertisement when the authentication is succeeded.

In view of the above circumstances, there is a need to provide an information processing apparatus, a method for processing information, and an information processing system that display display information containing personal information for a user who uses the apparatus without being seen by third parties.

### SUMMARY OF THE INVENTION

It is an object of the present invention to at least partially solve the problems in the conventional technology.

According to the present invention, there is provided an information processing apparatus connected to a managing apparatus that manages display information via a network, the information processing apparatus comprising: a communication unit that transmits apparatus identification information that identifies the information processing apparatus and apparatus information of the information processing apparatus to the managing apparatus and receives the display information corresponding to the apparatus identification information and the apparatus information from the managing apparatus; a reading unit that reads user identification information that identifies a user from a storage medium; an authenticating unit that authenticates a user by the read user identification information; a display controller that, when the user is authenticated, displays publicly-available first display information among the received display information on a display unit; and a determining unit that determines whether or not the storage medium is within a certain distance, wherein the display controller, when the storage medium is determined to be present within the certain distance, displays, on the display unit, second display information available to a specific user including an authenticated user among the received display information.

The present invention also provides a method for processing information executed by an information processing apparatus connected to a managing apparatus that manages display information via a network, the method comprising: communicating for transmitting apparatus identification information that identifies the information processing apparatus and apparatus information of the information processing apparatus to the managing apparatus and receiving the display information corresponding to the apparatus identification information and the apparatus information from the managing apparatus; reading user identification information that identifies a user from a storage medium; authenticating a user by the read user identification information; first display controlling for, when the user is authenticated, displaying publicly-available first display information among the received display information on a display unit; determining whether or not the storage medium is within a certain distance; and second display controlling for, when the storage medium is determined to be present within the certain distance, displaying, on the display unit, second display information available to a specific user including an authenticated user among the received display information.

The present invention also provides an information processing system comprising a managing apparatus that manages display information and an information processing apparatus connected via a network, the information processing system comprising: a storage unit that stores therein apparatus identification information that identifies the information processing apparatus and apparatus information of the information processing apparatus in association with the display information; a reading unit that reads user identification information that identifies a user from a storage medium; an authenticating unit that authenticates a user by the read user identification information; a display controller that, when the user is authenticated, displays, on a display unit, publicly-available first display information among the received display information; and a determining unit that determines whether or not the storage medium is within a certain distance, the display controller, when the storage medium is determined to be present within the certain distance, displaying, on the display unit, second display information available to a specific user including an authenticated user among the received display information.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an entire configuration of an information processing system according to an embodiment of the present invention;

FIG. 2 is an external view of an MFP according to the embodiment;

FIG. 3 is a configuration diagram of an operating unit provided in the MFP according to the embodiment;

FIG. 4 is a hardware configuration diagram of a main body constituting the MFP according to the embodiment;

FIG. 5 is a hardware configuration diagram of the operating unit and a reading device constituting the MFP according to the embodiment;

FIG. 6 is a schematic diagram illustrating an example of a software configuration of the MFP and the operating unit according to the embodiment;

FIG. 7 is a diagram illustrating a functional configuration example of the MFP according to the embodiment;

FIG. 8 is an explanatory diagram illustrating an example of closed advertisement data created containing personal information;

FIG. 9 is an explanatory diagram illustrating an example of open advertisement data created by publicly-available information;

FIG. 10 is an image diagram illustrating a process in which a user approaches the MFP and then advertisement data is displayed;

FIG. 11 is a diagram illustrating a functional configuration example of a content server according to the embodiment;

FIG. 12 is a diagram illustrating an example of variable apparatus information stored in the content server according to the embodiment;

FIG. 13 is a diagram illustrating an example of fixed apparatus information stored in the content server according to the embodiment;

FIG. 14 is a diagram illustrating an example of display condition information stored in the content server according to the embodiment;

FIG. 15 is a diagram illustrating an example of advertisement data management information stored in the content server according to the embodiment;

FIG. 16A is a sequence diagram illustrating a procedure of advertisement display processing in the MFP according to the embodiment;

FIG. 16B is a sequence diagram (continued) illustrating the procedure of the advertisement display processing in the MFP according to the embodiment; and

FIG. 17 is a flowchart illustrating the procedure of the advertisement display processing in the MFP according to the embodiment.

### DETAILED DESCRIPTION OF THE PREFERRED EMBODIMENTS

The following describes an embodiment of an information processing apparatus, a method for processing information, and an information processing system in detail with reference the attached drawings. The present embodiment shows an example in which the information processing apparatus is applied to a multifunction peripheral (MFP) that houses at least two functions among a plurality of functions such as copy, fax, and printer in a single casing, a printer, and a projector. The following embodiment describes the information processing system including the MFP as the information processing apparatus and a content server as a managing apparatus as an example.

In the information processing system according to the present embodiment, the MFP performs user authentication by a user ID (identifier) read from a storage medium such as a radio frequency identification (RFID) tag possessed by a user. When the user authentication is succeeded, advertisement data that fits the user among advertisement data (display information) received from the content server (the managing apparatus) is displayed in accordance with radio wave intensity of the storage medium. The user ID corresponds to user identification information.

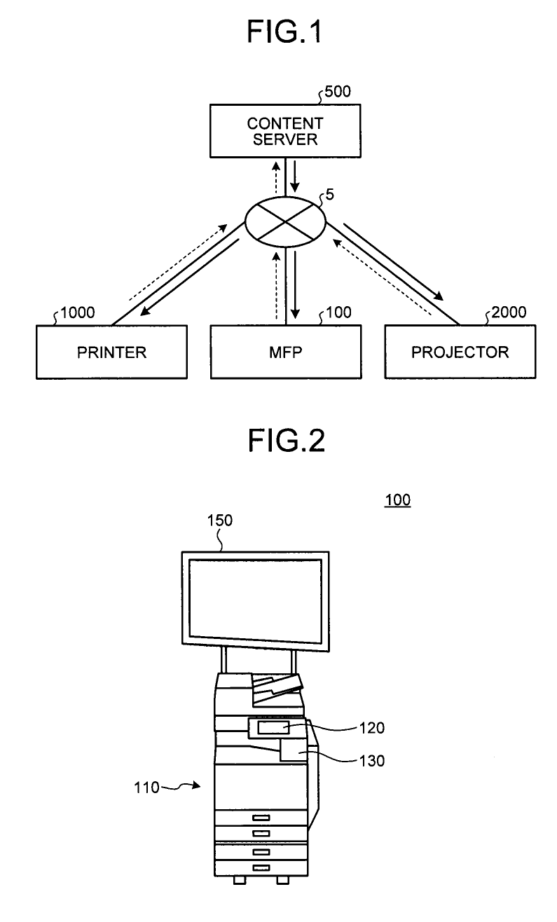

FIG. 1 is a diagram illustrating an entire configuration of the information processing system according to the embodiment. The information processing system illustrated in FIG. 1 connects a content server 500, an MFP 100, a printer 1000, and a projector 2000 via a network 5.

The content server 500 manages advertisement data to be distributed to the MFP 100 or the like in association with an apparatus ID that identifies the MFP 100 or the like and apparatus information of the MFP 100 or the like. When the MFP 100 transmits the apparatus ID and the apparatus information to the content server 500 at regular intervals, the content server 500 distributes advertisement data based on the received apparatus ID and apparatus information to the MFP 100. The dotted-line arrows in FIG. 1 indicate the flow of the apparatus ID and the apparatus information, whereas the solid-line arrows indicate the flow of distribution of the advertisement data. The apparatus ID corresponds to apparatus identification information.

FIG. 2 is an external view of the MFP according to the embodiment. As illustrated in FIG. 2, the MFP 100 includes a main body 110, an operating unit 120, a reading device 130, and a display apparatus 150.

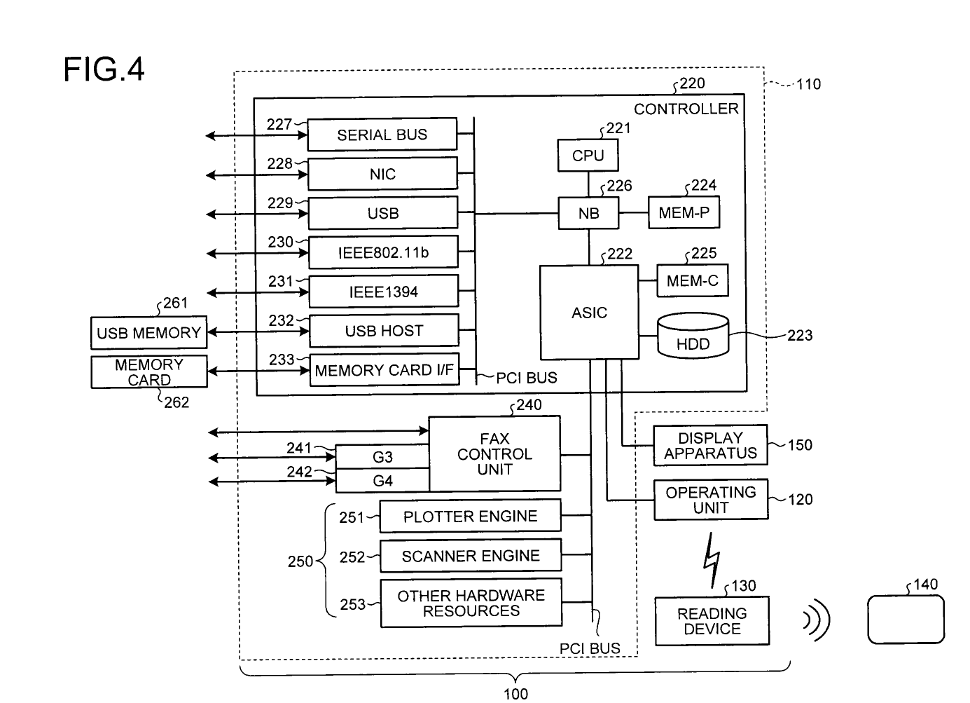

The main body 110 prints image data obtained by reading a document or image data received from a personal computer (PC) or the like on a recording medium such as a sheet. The reading device 130 reads information such as a user ID from an RFID tag 140 (refer to FIG. 4) possessed by the user.

The display apparatus 150 is an external screen (a first display unit) that mainly displays advertisement created by publicly-available information and is connected to the main body 110. In the present embodiment, the screen of the display apparatus 150 is a large screen and can be easily seen at a remote distance from the MFP 100.

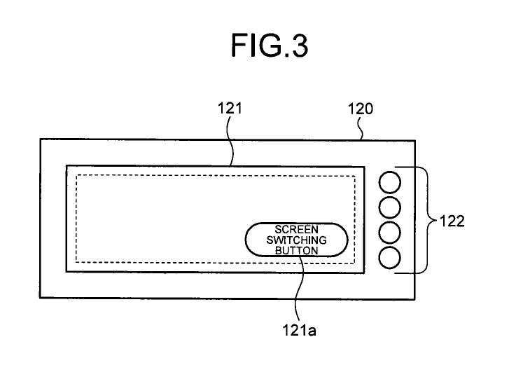

The operating unit 120 allows a user to perform operation input and displays an operating screen of the MFP, a job progress status, and advertisement created containing information available only to specific users. FIG. 3 is a configuration diagram of the operating unit provided in the MFP according to the embodiment.

As illustrated in FIG. 3, the operating unit 120 arranges an operating panel 121 (a second display unit) as a liquid crystal display (LCD) that is capable of operation by a touch panel and hard keys 122 that can be operated even when the operating panel 121 is turned off.

The operating panel 121 includes a “screen switching button” 121a that performs display switching between the display of the job progress status and the display of advertisement by being pressed down by the user. The hard keys 122 assign keys such as “Back,” “Display home screen,” and “Stop,” that are commonly used in displayed screens. The hard keys 122 can change their assignments according to later customization by users.

The following describes a hardware configuration of the main body 110 constituting the MFP 100. FIG. 4 is a hardware configuration diagram of the main body constituting the MFP according to the embodiment. As described above, the MFP 100 includes the main body 110, the operating unit 120, the reading device 130, and the display apparatus 150. FIG. 4 illustrates a hardware configuration of the main body 110.

The main body 110 includes a controller 220, a fax control unit 240, and an engine group 250. The fax control unit 240 further includes a G3 standard-compliant unit 241 and a G4 standard-compliant unit 242. The engine group 250 includes a plotter engine 251, a scanner engine 252, and other hardware resources 253.

The controller 220 includes a CPU 221, an ASIC 222, a hard disk drive (HDD) 223, a system memory (MEM-P) 224, a local memory (MEM-C) 225, and a north bridge (hereinafter, abbreviated as an NB) 226. Also included are a serial bus 227, a network interface card (NIC) 228, and a USB device 229. Also included are an IEEE802.11b device 230, an IEEE1394 device 231, a USB host 232, and a memory card I/F 233.

The serial bus 227, the NIC 228, the USB device 229, the IEEE802.11b device 230, the IEEE1394 device 231, the USB host 232, and the memory card I/F 233 are connected to the NB 226 via a PCI bus.

In the controller 220, the local memory 225, the HDD 223, and the like are connected to the ASIC 222. The CPU 221, the system memory 224, and the ASIC 222 are connected via the NB 226 as a CPU chip set. The fax control unit 240 and the engine group 250 are connected to the ASIC 222 via a PCI bus. The CPU 221 is a computer that controls the entire MFP 100.

The system memory 224 is a memory used as a memory for drawing or the like of the MFP 100. The local memory 225 is a memory used as a buffer for images to be copied, a sign buffer, or the like.

The ASIC 222 is an integrated circuit (IC) for image processing purposes having hardware elements for image processing. The HDD 223 is storage for storing therein various kinds of information. Examples of the information stored in the HDD 223 include destination data for facsimile transmission or destination data for e-mail (that is, address book data). Also included are history data for storing transmission histories of facsimile transmission, e-mail transmission, and the like and accumulated image data and accumulated document data as print job data. Also included are various kinds of computer programs, font data, and form data.

The serial bus 227, the NIC 228, the USB device 229, the IEEE802.11b device 230, the IEEE1394 device 231, the USB host 232, and the memory card I/F 233 are interfaces to be connected to portable storage devices of standards to which the respective devices conform. As illustrated in FIG. 4, for example, a USB memory 261 can be connected to the USB host 232, whereas a memory card 262 can be connected to the memory card I/F 233.

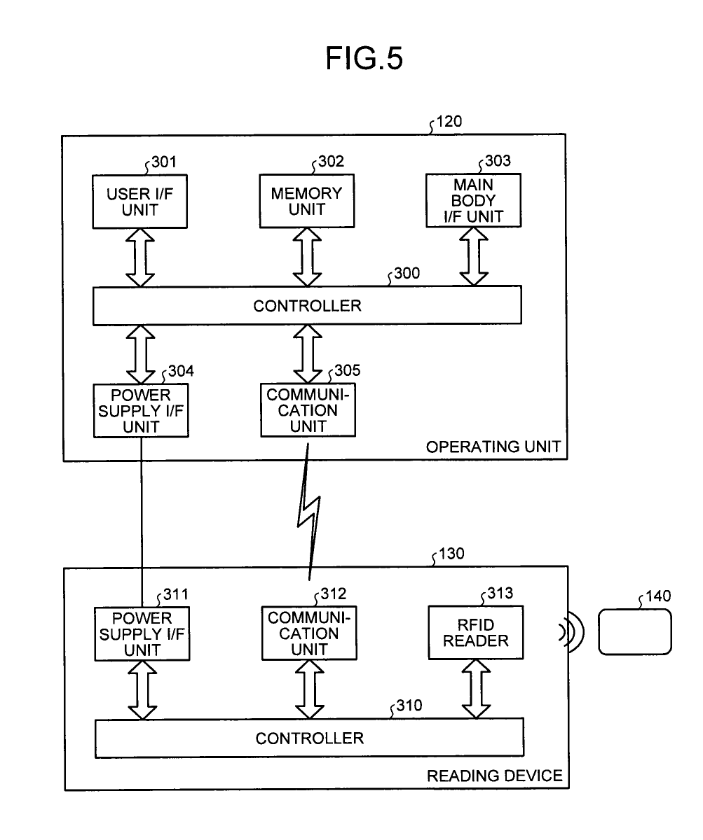

The following describes hardware configurations of the operating unit 120 and the reading device 130 constituting the MFP 100. FIG. 5 is a hardware configuration diagram of the operating unit 120 and the reading device 130 constituting the MFP 100 according to the embodiment.

The following first describes the hardware configuration of the operating unit 120. A controller 300 is a computer that controls the entire operating unit 120.

A user interface (I/F) unit 301 includes an LCD touch device, a touch panel, and hard keys. The user interface unit 301 is used when various kinds of operations are performed such as selection of services related to image processing to be executed by the main body 110, input of various kinds of set values for executing the services related to image processing, and input of an execution instruction for executing the services related to image processing. A display screen displayed on the LCD device of the user interface unit 301 is subjected to display control by the controller 300. Turning on and off of a backlight included in the LCD device is also controlled by the controller 300.

A memory unit 302 is used as a work memory when the controller 300 executes a process in the operating unit 120. The memory unit 302 also functions as a storage device for storing therein data transferred from the HDD 223 of the main body 110 of the MFP 100.

A main body interface (I/F) unit 303 is an interface transmitting and receiving signals between the operating unit 120 and the main body 110. With this configuration, signals based on the various operations performed by the user via the user interface unit 301 are transmitted to the main body 110 via the main body interface unit 303. Signals indicating an internal state of the main body 110 transmitted from the main body 110 are transmitted to the operating unit 120 via the main body interface unit 303 and are displayed on the user interface unit 301.

The main body interface unit 303 may be an electric contact, a universal serial bus (USB) interface, an infrared communication unit, or the like. In other words, regardless of whether the main body 110 and the operating unit 120 are in a physically connected state or a non-connected state, the main body 110 can execute the services related to image processing based on the various operations by the user on the operating unit 120.

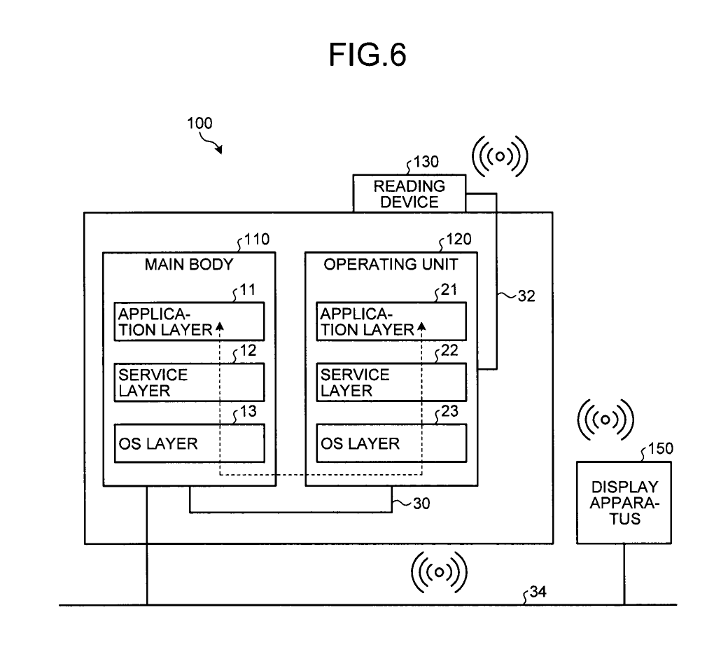

A power supply interface (I/F) unit 304 is an interface for connecting a power supply line 32 (refer to FIG. 6) that supplies electric power to the reading device 130. A communication unit 305 is a unit for performing wireless communication with the reading device 130. Via the communication unit 305, a reading starting instruction and a reading ending instruction are transmitted to the reading device 130, or information on the user such as a user ID is received from the reading device 130.

A hardware configuration (not illustrated) of the display apparatus 150 is equivalent to that of the operating unit 120 except the power supply interface unit 304 and the communication unit 305.

The following describes the hardware configuration of the reading device 130. A controller 310 is a computer that controls the entire reading device 130. A power supply interface (I/F) unit 311 is an interface of the reading device 130 for connecting the power supply line 32 (refer to FIG. 6) that supplies electric power to the reading device 130. The electric power supplied via the power supply interface unit 311 is input to the controller 310 and is distributed to a communication unit 312 and an RFID reader 313.

The communication unit 312 is a unit for performing wireless communication with the operating unit 120 and receives the reading starting instruction and the reading ending instruction from the operating unit 120 and transmits the information on the user such as a user ID thereto.

The RFID reader 313 reads pieces of information on the user that are recorded in the RFID tag 140 and transmits the information to the operating unit 120 via the communication unit 312.

The following describes a software configuration of the MFP 100. FIG. 6 is a schematic diagram illustrating an example of the software configuration of the MFP and the operating unit according to the embodiment.

The main body 110 of the MFP 100 includes an application layer 11, a service layer 12, and an OS layer 13. The application layer 11, the service layer 12, and the OS layer 13 are in reality various pieces of software stored in the HDD 223 or the like. The CPU 221 executes these pieces of software to provide various functions.

The software of the application layer 11 is application software (which may be referred to as simply an “application” in the following description) for providing certain functions by operating hardware resources. Examples of the application include a copy application for providing copying function, a scanner application for providing scanner function, a fax application for providing fax function, and a printer application for providing printer function.

The software of the service layer 12 is software that is interposed in between the application layer 11 and the OS layer 13 and provides an interface for utilizing hardware resources included in the main body 110 for the application. More specifically, the software of the service layer 12 is software for providing functions of receiving operation requests to the hardware resources and performing arbitration of the operation requests. Examples of the operation requests received by the service layer 12 include requests for reading by a scanner and printing by a plotter.

The function as the interface by the service layer 12 is provided not only to the application layer 11 of the main body 110 but also to an application layer 21 of the operating unit 120. In other words, the application layer 21 (application) of the operating unit 120 can also implement functions utilizing the hardware resources of the main body 110 via the interface function of the service layer 12.

The software of the OS layer 13 is basic software (an operating system) for providing basic function for controlling the hardware included in the main body 110. The software of the service layer 12 converts requests for utilizing the hardware resources from various kinds of applications into commands interpretable by the OS layer 13 and delivers the commands to the OS layer 13. The commands are executed by the software of the OS layer 13, thereby causing the hardware resources to operate in accordance with the requests by the applications.

Similarly, the operating unit 120 includes the application layer 21, a service layer 22, and an OS layer 23. The application layer 21, the service layer 22, and the OS layer 23 included in the operating unit 120 are similar to the main body 110 side in its hierarchical structure. However, functions provided by an application of the application layer 21 and the type of operation requests that can be received by the service layer 22 are different from those of in the main body 110 side. Although the application of the application layer 21 may be software that operates the hardware resources included in the operating unit 120 and provides certain functions, it is software for mainly providing functions of a user interface (UI) for performing operation and display related to functions (copying function, scanner function, fax function, and printer function) included in the main body 110.

In the present embodiment, in order to maintain functions independent from each other, the software of the OS layer 13 of the main body 110 and that of the OS layer 23 of the operating unit 120 are different from each other. In other words, the main body 110 and the operating unit 120 operate on separate operating systems independently of each other. It can be configured, for example, that the software of the OS layer 13 of the main body 110 uses Linux (registered trademark), whereas the software of the OS layer 23 of the operating unit 120 uses Android (registered trademark).

As described above, in the present embodiment, the main body 110 and the operating unit 120 operate on the separate operating systems. Given this situation, the communication between the main body 110 and the operating unit 120 is performed not as interprocess communication within a common apparatus, but as communication between different apparatuses, which includes operation (command communication) for conveying operation input (instruction contents from the user) received by the operating unit 120 to the main body 110 and operation by which the main body 110 notifies the operating unit 120 of an event. The operating unit 120 performs the command communication to the main body 110, thereby enabling the function of the main body 110 to be used. Examples of the event notified from the main body 110 to the operating unit 120 include an operation execution status in the main body 110 and contents set by the main body 110.

In the MFP 100 of the present embodiment, the main body 110 and the operating unit 120 are connected via an exclusive line (a control line or a power supply line) 30. Consequently, electric power supply to the operating unit 120 is performed from the main body 110 via the exclusive line 30.

The main body 110 and the operating unit 120 can be connected to an external network via Ethernet (registered trademark) or wirelessly (wireless LAN or Bluetooth (registered trademark)). As illustrated in FIG. 6, the present embodiment illustrates an example in which the main body 110 is connected via Ethernet, whereas the operating unit 120 is connected via wireless LAN. Through this network, the main body 110 transmits the apparatus ID and the apparatus information to the content server 500, receives the advertisement data from the content server 500, transfers the received advertisement data to the operating unit 120, and displays the advertisement data.

Although FIG. 6 illustrates an example in which the main body 110 and the operating unit 120 can separately be connected to the external network, the MFP 100 can be configured as a single system by transmitting and receiving data via the exclusive line 30.

As illustrated in FIG. 6, the reading device 130 that can read the user ID or the like from the RFID tag 140 in a noncontact manner is connected to the operating unit 120. Electric power is supplied to the reading device 130 from the operating unit 120 via the power supply line 32. The user ID or the like read by the reading device 130 is transmitted to the operating unit 120 wirelessly (via wireless LAN or Bluetooth). It may be configured that the reading device 130 is provided within the MFP 100 to transmit and receive data via the power supply line 32 not wirelessly.

As illustrated in FIG. 6, in addition to the operating unit 120, the display apparatus 150, which is an external screen for display, is connected to the main body 110 via Ethernet or the like via an exclusive line 34.

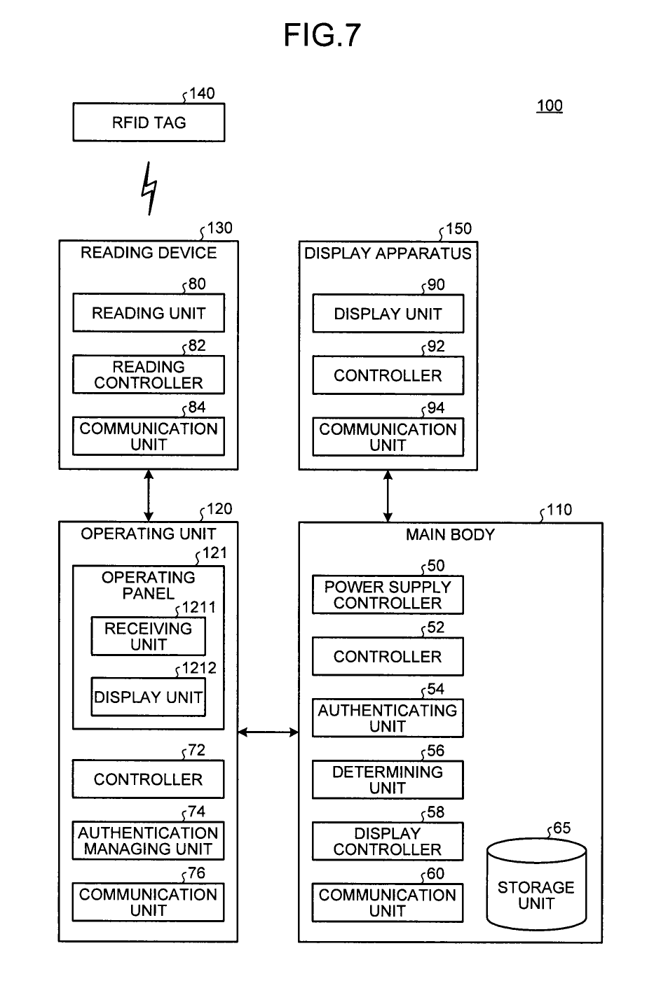

The following describes a functional configuration of the MFP 100. FIG. 7 is a diagram illustrating a functional configuration example of the MFP according to the embodiment. As illustrated in FIG. 7, the MFP 100 includes the main body 110, the operating unit 120, the reading device 130, and the display apparatus 150.

The following first describes the function of the reading device 130. The reading device 130 includes a reading unit 80, a reading controller 82, and a communication unit 84.

When the RFID tag 140 (a storage medium) possessed by the user enters within a communication distance, the reading unit 80 receives and reads the user ID that identifies the user from the RFID tag 140 in a noncontact manner. The reading unit 80 receives the user ID at regular intervals, and when the RFID tag 140 continues to be present within the communication distance, the same user ID is read a plurality of times. When a plurality of different RFID tags 140 enter within the communication distance, the reading unit 80 reads the different user IDs or the like. The reading unit 80 corresponds to a reading unit.

The reading controller 82 controls the reading unit 80 to perform reading.

The communication unit 84 transmits the user ID that the reading unit 80 has read from the RFID tag 140 and radio wave intensity emitted when the user ID is read to the main body 110 via the operating unit 120.

The following describes the function of the operating unit 120. The operating unit 120 includes the operating panel 121, a controller 72, an authentication managing unit 74, and a communication unit 76.

The operating panel 121 further includes a receiving unit 1211 and a display unit 1212. The receiving unit 1211 receives various kinds of operation input from the user. In the present embodiment, the receiving unit 1211 receives touch operation by the user on a screen (a face on which images are displayed) of the operating panel 121 that installs touch panel function and input of various kinds of information by operation on the hard keys 122.

The display unit 1212 displays various kinds of images. In the present embodiment, the display unit 1212 corresponds to the screen (the face on which images are displayed) of the operating panel 121. The display unit 1212 displays various kinds of screens such as an operating screen. The display unit 1212 displays closed advertisement data (second display information) as advertisement data created containing information (personal information or the like) available only to specific users including a user who has succeeded in authentication. The display unit 1212 corresponds to the second display unit.

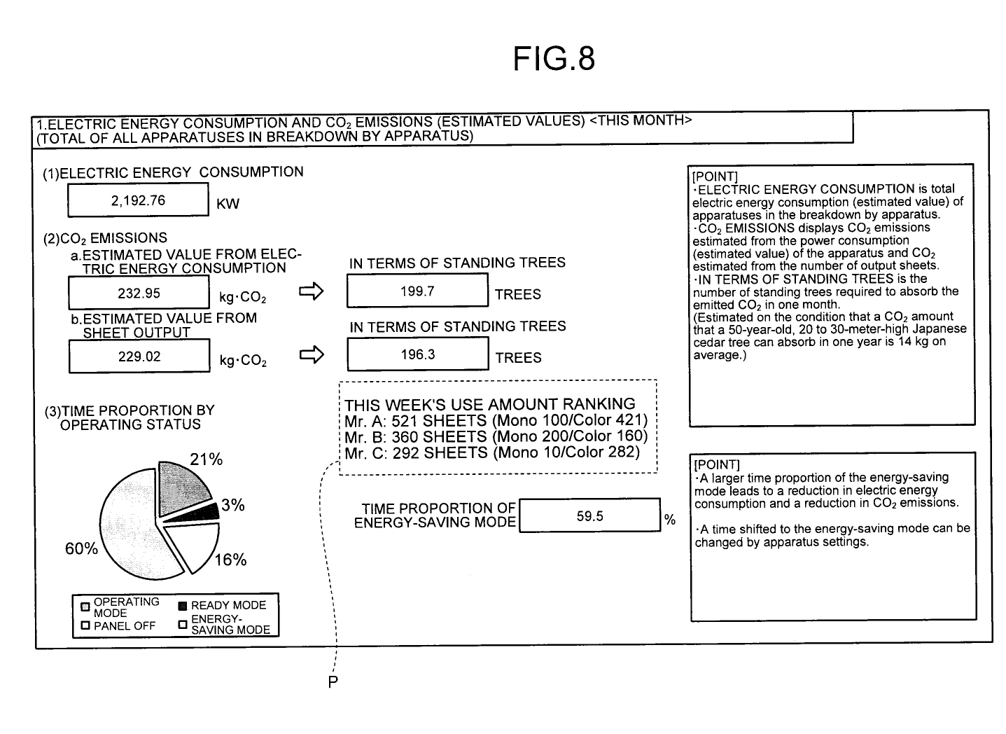

The following describes the closed advertisement data. FIG. 8 is an explanatory diagram illustrating an example of the closed advertisement data created containing personal information. As illustrated in FIG. 8, the closed advertisement data displays various kinds of information such as electric energy consumption and CO₂ emissions and personal information (personal use amount information) such as Mr. A: 521 sheets; Ms. B: 360 sheets; and Mr. C: 292 sheets (P in FIG. 8).

Thus, the closed advertisement data illustrated in FIG. 8 displays the personal use amount information, and the closed advertisement data is displayed when a user (an administrator, for example) who has browsing authority comes to the front of the MFP 100. This closed advertisement data is created based on the apparatus information received by the content server 500 from the MFP 100.

The controller 72 controls the operating unit 120 and performs control to display the operating screen received from the main body 110, the closed advertisement data, and the like on the display unit 1212. The controller 72 performs control to transmit the operation input received from the receiving unit 1211, the user ID and the radio wave intensity received from the reading device 130, and the like to the main body 110.

The authentication managing unit 74 transmits the user ID read by the reading device 130 to the main body 110 and requests user authentication.

The communication unit 76 gives and receives various kinds of information and signals to and from the main body 110 and the reading device 130. In the present embodiment, the communication unit 76 receives the user ID and the radio wave intensity read from the reading device 130 and transmits the user ID and the radio wave intensity to the main body 110. The communication unit 76 receives various kinds of screens such as the operating screen and the closed advertisement data to be displayed on the display unit 1212 from the main body 110. The communication unit 76 transmits, to the main body 110, the operation that is input by the user and received by the receiving unit 1211.

The following describes the function of the display apparatus 150. The display apparatus 150 includes a display unit 90, a controller 92, and a communication unit 94.

The display unit 90 displays various kinds of images. In the present embodiment, the display unit 90 displays open advertisement data (first display information) that a user who has succeeded in user authentication can browse and is created by publicly-available information. The display unit 90 corresponds to the first display unit.

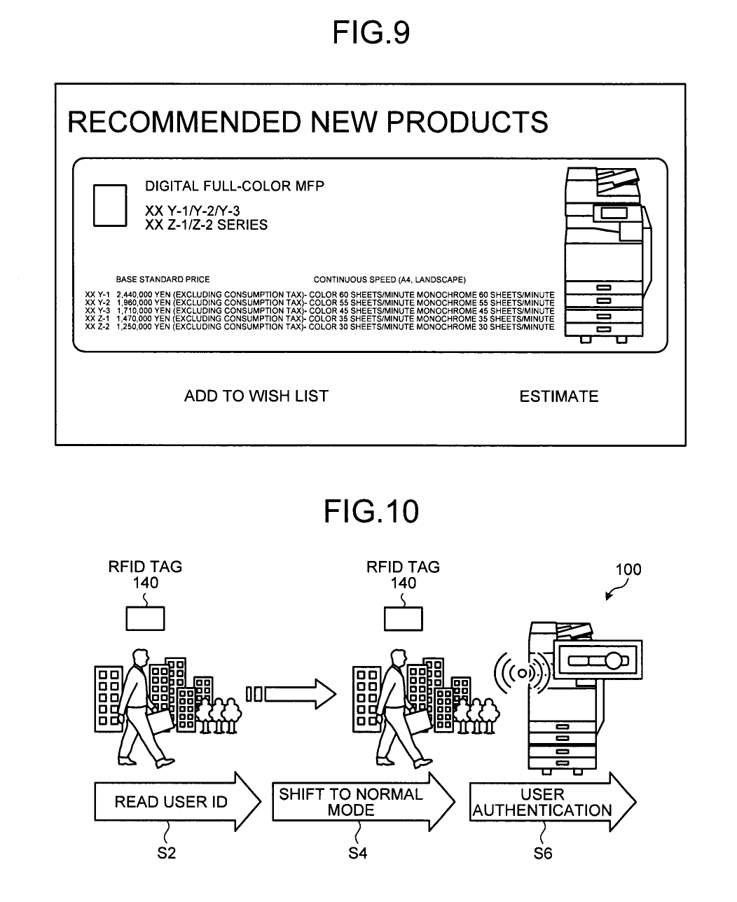

The following describes the open advertisement data. FIG. 9 is an explanatory diagram illustrating an example of the open advertisement data created by the publicly-available information. As illustrated in FIG. 9, the open advertisement data displays information on recommended new products, which does not include any personal information, and the open advertisement data is displayed when a user (an administrator, for example) who has browsing authority approaches and user authentication is succeeded.

The controller 92 controls the display apparatus 150 and performs control to display the open advertisement data received from the main body 110 and the like on the display unit 90.

The communication unit 94 gives and receives various kinds of information and signals to and from the main body 110. In the present embodiment, the communication unit 94 receives the open advertisement data displayed on the display unit 90.

The following describes the function of the main body 110. The main body 110 includes a storage unit 65, a power supply controller 50, a controller 52, an authenticating unit 54, a determining unit 56, a display controller 58, and a communication unit 60.

The storage unit 65 is a storage medium such as an HDD and a memory that stores therein the advertisement data (the closed advertisement data and the open advertisement data) received from the content server 500. The storage unit 65 stores therein pieces of advertisement data each containing a display condition that associates an advertisement ID that identifies the advertisement data, a user ID of a user having browsing authority, and whether or not the data is publicly-available (open or closed) with each other in an attached manner. Whether or not the data is publicly-available defines whether the advertisement data is advertisement created by publicly-available information that is permitted to be seen by third parties irrelevant to the users of the MFP 100 or advertisement created containing information available only to the specific users. This display condition is information to be attached to the advertisement data from part of display condition information (refer to FIG. 14) when the content server 500 transmits the advertisement data to the MFP 100. The storage unit 65 corresponds to a storage unit.

The storage unit 65 stores therein user information containing the user ID that is used when a user is authenticated. This user information and the read user ID are compared with each other, thereby authenticating the user.

The power supply controller 50 controls the power supply of the MFP 100. In the present embodiment, the power supply controller 50 performs control processing to switch between an energy-saving mode that reduces power consumption and a normal mode that performs image processing. The power supply controller 50 performs control processing to cut off the power supply and set a sleep state for part of the hardware resources when the mode is switched to the energy-saving mode and to restore the cut off power supply and set an idle state when the mode is switched to the normal mode.

The controller 52 controls the entire MFP 100.

The authenticating unit 54 authenticates a user depending on whether or not the user ID read by the reading device 130 received from the operating unit 120 is contained in the user information stored in the storage unit 65. The authenticating unit 54 corresponds to an authenticating unit.

When a plurality of different user IDs are read, the authenticating unit 54 authenticates a user by a user ID selected by the determining unit 56. When the same user ID is received a plurality of times, the authenticating unit 54 authenticates a user when it is determined by the determining unit 56 that the user has approached.

The determining unit 56 determines whether or not the same user ID has been read a plurality of times (a preset number of times) by the reading device 130. If the user ID has been read a plurality of times, the determining unit 56 determines whether or not radio wave intensity when the user ID is read is increasing. The determining unit 56 determines that the user has approached the MFP 100, if the radio wave intensity is increasing, and determines that the user has left the MFP 100, if the radio wave intensity is attenuating. The determining unit 56 corresponds to a determining unit.

The determining unit 56 determines whether or not a plurality of different user IDs have been read by the reading device 130. If the different user IDs have been read, the determining unit 56 selects a user ID read from the RFID tag 140 that has emitted the highest radio wave intensity and recognizes the user having the RFID tag 140 as the user using the MFP 100.

The determining unit 56 determines whether or not the radio wave intensity emitted by the RFID tag 140 when the user ID is read by the reading device 130 exceeds a preset threshold (X). With this operation, it can be determined that whether or not the user having the RFID tag 140 is present within a certain distance from the MFP 100. Although the present embodiment determines whether or not the user is present within the certain distance from the MFP 100 by the radio wave intensity, that is not limiting, and the distance between the user and the MFP may be determined by a sensor, for example.

When the user authentication by the authenticating unit 54 is succeeded, the display controller 58 refers to the display condition attached to the advertisement data stored in the storage unit 65. The display controller 58 displays, on the display unit 90 of the display apparatus 150, publicly-available advertisement data among advertisement data of which the display condition contains the user ID that has succeeded in user authentication. The display controller 58 corresponds to a display controller.

The “advertisement data of which the display condition contains the user ID that has succeeded in user authentication” indicates that the user having the RFID tag 140 from which the user ID that has succeeded in the user authentication has been read has browsing authority. In this case, even when the user is present at a location some distance away from the MFP 100, the publicly-available open advertisement data is displayed on the large-screen display unit 90 different from the operating unit 120. Given this situation, the user can see the publicly-available open advertisement data before operating the MFP 100, and operation by the user on the operating screen or the like displayed on the operating unit 120 is not inhibited.

If the user authentication by the authenticating unit 54 has been failed, the display controller 58 displays an error message indicating that the user authentication has been failed on the display unit 1212 of the operating unit 120.

If it is determined that the radio wave intensity emitted by the RFID tag 140 when the user ID is read exceeds the threshold (X), the display controller 58 refers to the display condition attached to the advertisement data stored in the storage unit 65. The display controller 58 then displays, on the display unit 1212 of the operating unit 120, the closed advertisement data available only to the specific users among the advertisement data of which the display condition contains the user ID that has succeeded in user authentication.

In this case, when the user comes to the front of the MFP 100, for example, the closed advertisement data available only to the specific users is displayed on the display unit 1212 of the operating unit 120 that is positioned near the hand of the user. Given this situation, the advertisement data for the user having browsing authority who has succeeded in the user authentication can be displayed without being seen by third parties irrelevant to the displayed information.

Furthermore, when certain operation input by the user is received from the receiving unit 1211 with the closed advertisement data displayed on the display unit 1212, the display controller 58 switches the closed advertisement data displayed on the display unit 1212 to the operating screen to be displayed that performs operation input to the MFP 100. Examples of the certain operation input include operation input to press down the “screen switching button” 121a (refer to FIG. 3) provided on the operating panel 121.

The communication unit 60 transmits the apparatus ID that identifies the MFP 100 and the apparatus information of the MFP 100 to the content server 500. The communication unit 60 receives advertisement data that corresponds to the transmitted apparatus ID and apparatus information and to which the display condition is attached from the content server 500. The communication unit 60 corresponds to a communication unit.

The communication unit 60 gives and receives various kinds of information and signals to and from the operating unit 120 and the display apparatus 150. In the present embodiment, the communication unit 60 receives the user ID and the radio wave intensity read from the reading device 130 from the operating unit 120. The communication unit 60 transmits various screens such as the operating screen to be displayed on the display unit 1212 and the closed advertisement data to the operating unit 120. The communication unit 60 receives the operation input by the user received by the receiving unit 1211 from the operating unit 120. The communication unit 60 transmits the open advertisement data to be displayed on the display unit 90 to the display apparatus 150.

FIG. 10 is an image diagram illustrating a process in which a user approaches the MFP and then advertisement data is displayed. As illustrated in FIG. 10, first, when the user approaches the MFP 100, and the RFID tag 140 possessed by the user enters within the communication distance, the reading device 130 of the MFP 100 reads the user ID (Step S2).

When the user approaches the MFP 100, the power supply controller 50 of the MFP 100 is shifted to the normal mode from the energy-saving mode (Step S4). The authenticating unit 54 of the MFP 100 authenticates the user by the read user ID (Step S6). When user authentication is succeeded, the display controller 58 of the MFP 100 displays the open advertisement data on the display unit 90 of the display apparatus 150, and when the user further comes to the front of the MFP 100, displays the closed advertisement data on the display unit 1212 of the operating unit 120.

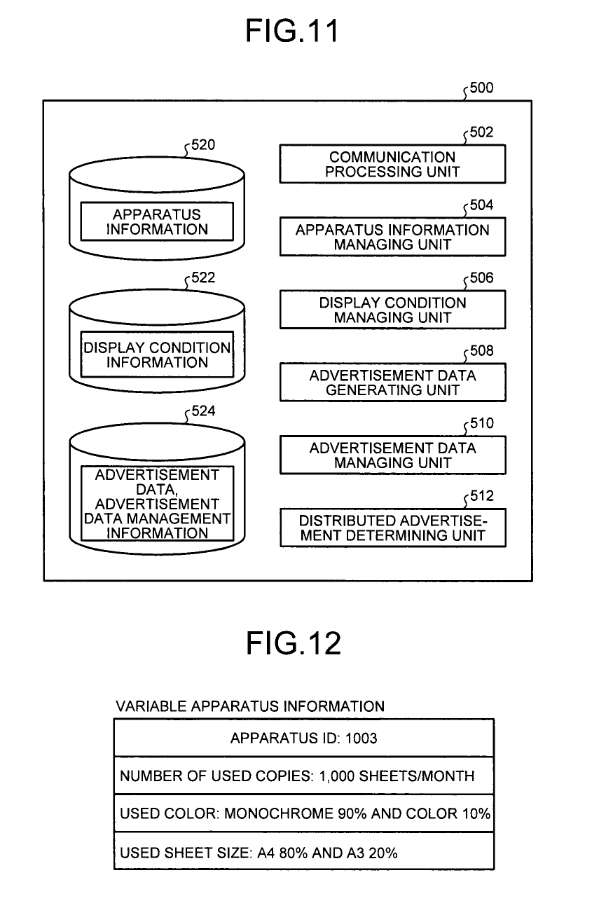

The following describes a functional configuration of the content server 500. FIG. 11 is a diagram illustrating a functional configuration example of the content server according to the embodiment. As illustrated in FIG. 11, the content server 500 includes storage units 520, 522, and 524, an communication processing unit 502, an apparatus information managing unit 504, a display condition managing unit 506, an advertisement data generating unit 508, an advertisement data managing unit 510, and a distributed advertisement determining unit 512.

The storage unit 520 is a storage medium such as an HDD and a memory that stores therein the apparatus information of the MFP 100 received from the MFP 100 by the communication processing unit 502. The apparatus information contains the latest apparatus information in association with the apparatus ID. Examples of the apparatus information include variable apparatus information that varies and requires an update in a short time such as every month and fixed apparatus information that does not vary very much in a short time.

The following first describes the variable apparatus information. FIG. 12 is a diagram illustrating an example of the variable apparatus information stored in the content server according to the embodiment. As illustrated in FIG. 12, for example, the variable apparatus information contains information on the usage of the MFP such as the number of used copies, the ratios of used colors, and the ratios of used sheet sizes for each apparatus ID.

The example in FIG. 12 indicates that, in the case of an MFP with an apparatus ID of 1003, the number of used copies is 1,000 sheets per month, for used colors, monochrome accounts for 90% and color 10%, and for used sheet sizes, A4 accounts for 80% and A3 20%. For an MFP under a maintenance contract, such variable apparatus information is, for example, transmitted to the content server 500 at regular intervals and updated monthly. The variable apparatus information is also used for sheet supply, billing, or the like.

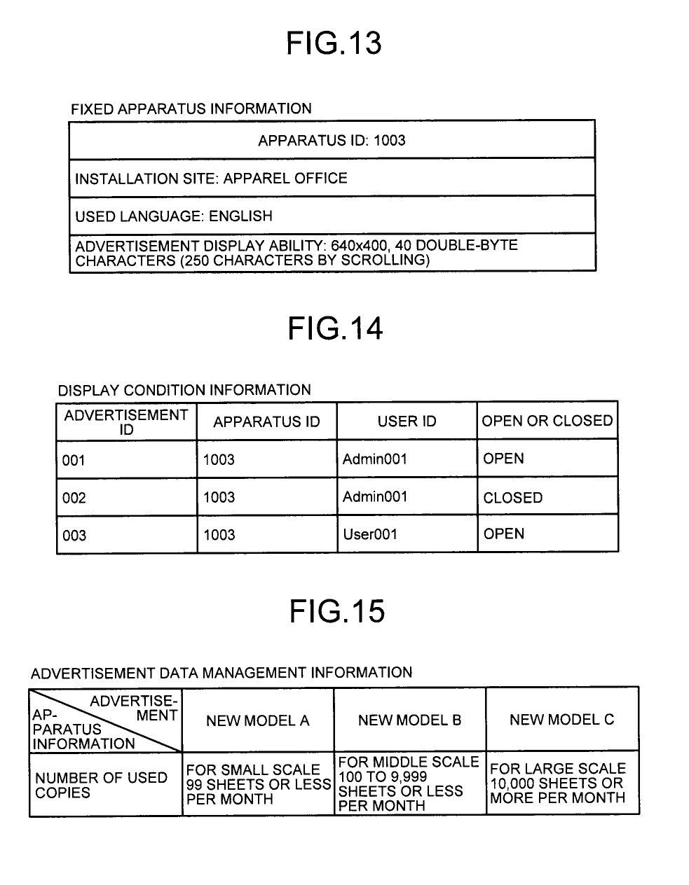

The following describes the fixed apparatus information. FIG. 13 is a diagram illustrating an example of the fixed apparatus information stored in the content server according to the embodiment. As illustrated in FIG. 13, for example, the fixed apparatus information contains installation site, used language, and advertisement display ability for each apparatus ID.

The example in FIG. 13 indicates that, in the case of the MFP with an apparatus ID of 1003, an installation site is an apparel office, a used language is English, and an advertisement display ability enables double-byte 40 characters to be displayed with a resolution of 640×400. Such fixed apparatus information may be set in the content server 500 at the installation of the apparatus or transmitted together with the variable information transmitted at regular intervals.

The storage unit 522 is a storage medium such as an HDD and a memory that stores therein the display condition information that associates the display condition of the advertisement data for each apparatus ID. FIG. 14 is a diagram illustrating an example of the display condition information stored in the content server according to the embodiment. As illustrated in FIG. 14, the display condition information contains the advertisement ID that identifies the advertisement, the advertisement ID being associated with the apparatus ID, the user ID having browsing authority for the advertisement data, and whether the data is open or closed (whether publicly-available) each other. FIG. 14 indicates that, for example, the advertisement data with an advertisement ID of “001” is advertisement data displayed by the MFP with an apparatus ID of “1003” and is open advertisement data for an administrator with a user ID of “Admin001.” FIG. 14 indicates that the advertisement data with an advertisement ID of “003” is advertisement data displayed by the MFP with an apparatus ID of “1003” and is open advertisement data for a general user with a user ID of “User001.”

The storage unit 524 is a storage medium such as an HDD and a memory that stores therein advertisement data to be distributed to the MFP. The advertisement data is generated by the advertisement data generating unit 508 and is stored in the storage unit 524.

The storage unit 524 stores therein advertisement data management information to be referred to when the advertisement data is distributed. The advertisement data management information is information for selecting which advertisement data is distributed, in which, for example, information on each advertisement data is associated with the apparatus information. FIG. 15 is a diagram illustrating an example of the advertisement data management information stored in the content server according to the embodiment. FIG. 15 indicates, for example, that three kinds (A through C) of advertisement (digital information containing images and texts for electronic distribution) of new models of the MFP are stored in association with the number of used copies as one piece of the apparatus information.

The information processing unit 502 receives the apparatus ID and the apparatus information of the MFP 100 from the MFP 100. The information processing unit 502 then transmits the advertisement data corresponding to the apparatus ID and the apparatus information determined by the distributed advertisement determining unit 512 with pertinent part from the display condition information attached as the display condition to the MFP 100.

The apparatus information managing unit 504 manages the apparatus information stored in the storage unit 520. Specifically, the apparatus information managing unit 504, for example, stores therein the apparatus ID and the apparatus information received from the MFP 100 by overwriting (updating) the apparatus information stored in the storage unit 520.

The display condition managing unit 506 manages the display condition information stored in the storage unit 522. Specifically, for example, when the advertising data is newly generated, the display condition managing unit 506 registers the apparatus ID of the subject apparatus (an MFP or the like), the user ID of the user having browsing authority, and whether or not the data is publicly-available (open or closed) in association with the advertisement ID.

The advertisement data generating unit 508 generates the closed advertisement data containing the apparatus information received from the MFP 100.

The advertisement data managing unit 510 manages the advertisement data and the advertisement data management information stored in the storage unit 524. Specifically, when the advertisement data is newly generated, for example, the advertisement data managing unit 510 stores therein the advertisement data and classifies advertisements distributed for each content of the apparatus information and registers the advertisements in the advertisement data management information.

The distributed advertisement determining unit 512 refers to the apparatus information of the MFP and the advertisement data management information for each apparatus ID of the MFP and determines the advertisement data to be distributed. Specifically, when the distributed advertisement determining unit 512 determines the advertisement data to be distributed by the number of used copies as the apparatus information, for example, referring to the variable apparatus information in FIG. 12 reveals that the MFP 100 with an apparatus ID of 1003 uses 1,000 sheets per month. Given this situation, the distributed advertisement determining unit 512 refers to the advertisement data management information in FIG. 15 and can determine that it is appropriate to distribute the advertisement data of the new model B for an apparatus that uses 100 to 9,999 sheets per month.

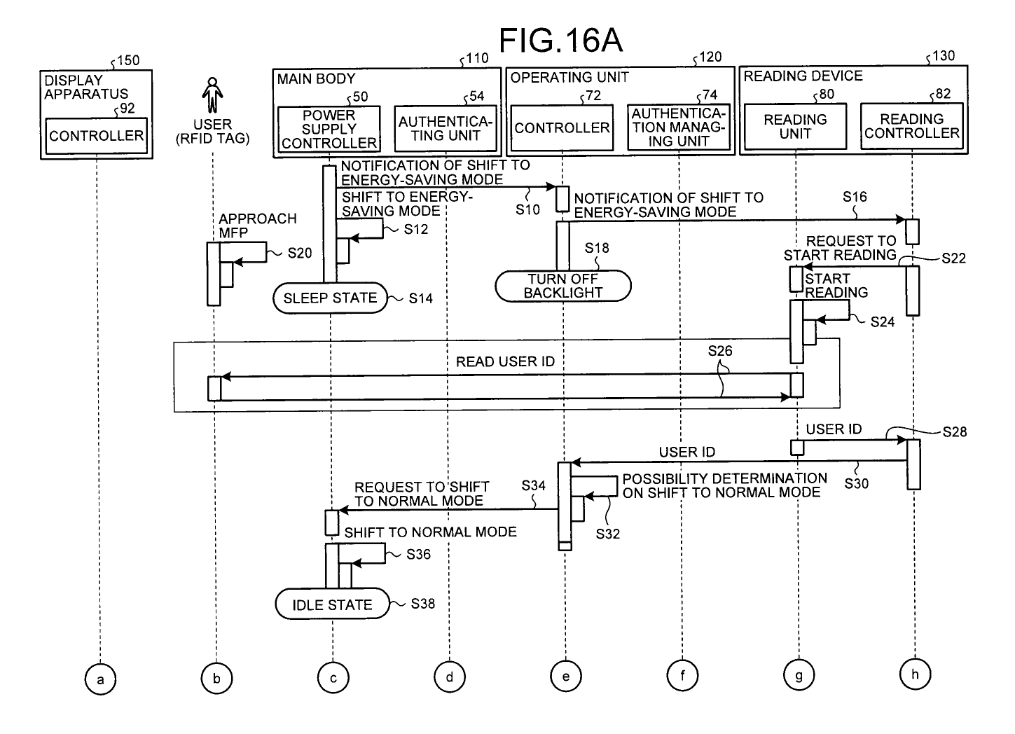

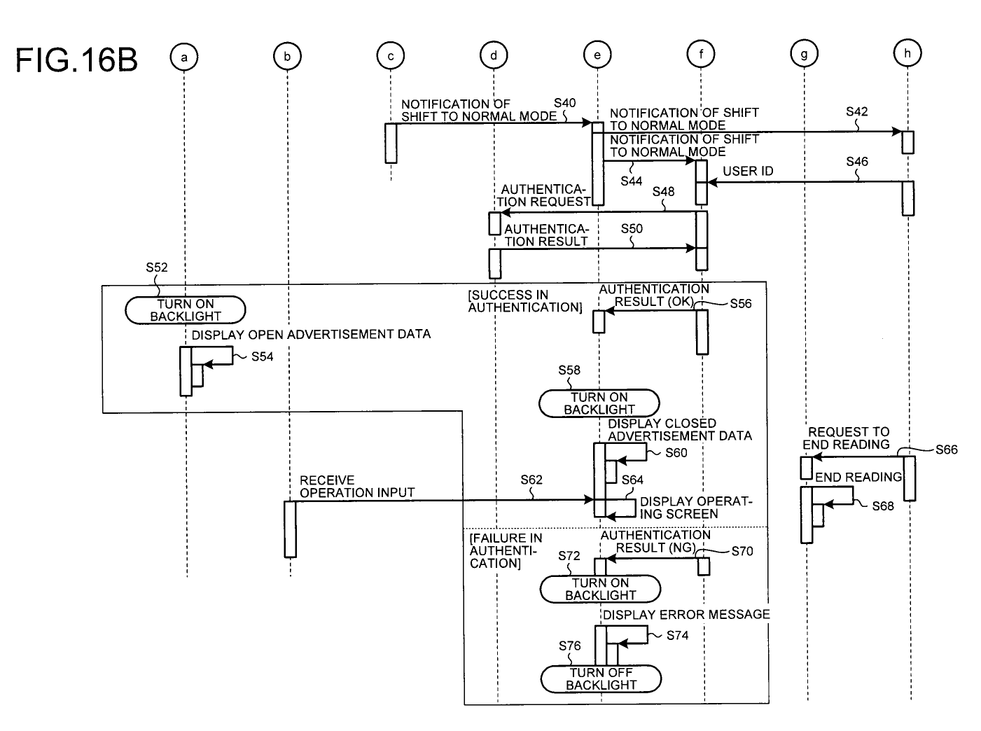

The following describes a procedure of processing in which a user approaches the MFP 100 and then advertisement is displayed. FIG. 16A and FIG. 16B are sequence diagrams illustrating a procedure of advertisement display processing in the MFP according to the embodiment. FIG. 16A and FIG. 16B illustrate an example of starting the reading of the user ID by the reading device 130 when the MFP 100 is in an energy-saving mode state. The following describes a procedure starting from a state after being transitioned to the energy-saving mode state along the sequence.

When a signal based on various kinds of operations performed by the user on the operating unit 120 is not transmitted for a preset certain time, the power supply controller 50 of the main body 110 transmits a notification of shift to the energy-saving mode to the controller 72 of the operating unit 120 (Step S10).

The power supply controller 50 that has performed the notification of shift to the energy-saving mode shifts the main body 110 to the energy-saving mode (Step S12). With this operation, the main body 110 turns into the sleep state (a state in which the power supply is cut off for part of the hardware) (Step S14).

The controller 72 of the operating unit 120 that has received the notification of shift to the energy-saving mode transmits the notification to the reading controller 82 of the reading device 130 (Step S16). The controller 72 of the operating unit 120 turns off the backlight of the operating panel 121 (Step S18). In this situation, the CPU of the operating unit 120 is operable. Thereafter, the user having the RFID tag 140 approaches the MFP 100 (Step S20).

When the reading controller 82 of the reading device 130 receives the notification of shift to the energy-saving mode, the reading controller 82 issues a request to start reading to the reading unit 80 (Step S22). The reading unit 80 that has received the request to start reading starts reading processing of the user ID from the RFID tag 140 (Step S24).

The reading unit 80 that has started the reading processing starts radio wave transmission at a certain cycle. In this situation, when the user having the RFID tag 140 approaches within the communication distance from the MFP 100, the RFID tag 140 receives the radio wave transmitted by the reading unit 80. The RFID tag 140 that has received the radio wave transmits the recorded user ID, thereby causing the reading unit 80 to read the user ID (Step S26).

The reading unit 80 receives the radio wave transmitted from the RFID tag 140, thereby detecting the user ID. The detected user ID is transmitted to the reading controller 82 together with the radio wave intensity of the signal emitted when the user ID is read (Step S28). The reading controller 82 transmits the read user ID and the radio wave intensity to the controller 72 of the operating unit 120 (Step S30).

When the controller 72 of the operating unit 120 receives the user ID and the radio wave intensity, if it is determined by the determining unit 56 (refer to FIG. 7) that the user has approached, the controller 72 performs determination (possibility determination on shift to the normal mode) whether the mode is shifted to the normal mode (Step S32). Shifting the mode to the normal mode when the user ID is read can prevent unnecessary shift from the energy-saving mode.

If a result of the possibility determination on shift to the normal mode indicates that the user who has approached has shift authority to the normal mode, the controller 72 of the operating unit 120 transmits a request to shift to the normal mode to the power supply controller 50 of the main body 110 (Step S34).

When the power supply controller 50 of the main body 110 receives the request to shift to the normal mode from the controller 72 of the operating unit 120, the power supply controller 50 shifts the main body 110 to the normal mode (Step S36). With this operation, the main body 110 turns into an idle state (a state in which the power supply is applied to the hardware resources) (Step S38). The power supply controller 50 then transmits a notification of shift to the normal mode indicating that shift to the normal mode has completed to the controller 72 of the operating unit 120 (Step S40).

The controller 72 of the operating unit 120 that has received the notification of shift to the normal mode transfers the notification of shift to the normal mode to the reading controller 82 of the reading device 130 and the authentication managing unit 74 (Steps S42 and S44). The reading controller 82 that has received the notification of shift to the normal mode transmits the user ID and the radio wave intensity received when the request to shift to the normal mode was transmitted to the authentication managing unit 74 of the operating unit 120 (Step S46).

The authentication managing unit 74 that has received the notification of shift to the normal mode transmits an authentication request that requests user authentication for the read user ID to the authenticating unit 54 of the main body 110 (Step S48). The authenticating unit 54 that has received the authentication request refers to the user information stored in the storage unit 65 and authenticates the user with respect to the read user ID. An authentication result about whether or not the user authentication by the authenticating unit 54 has been succeeded is transmitted to the authentication managing unit 74 (Step S50).

If the user authentication by the authenticating unit 54 has been succeeded, by a command from the display controller 58 (refer to FIG. 7) of the main body 110, the controller 92 of the display apparatus 150 turns on a backlight of the display unit 90 (refer to FIG. 7) (Step S52) and displays the open advertisement data on the display unit 90 (Step S54).

When the received authentication result indicates that the user authentication has been succeeded, the authentication managing unit 74 notifies the controller 72 of the operating unit 120 of the fact (Step S56). When the user authentication has been succeeded, and the user comes to the immediate front of the MFP 100, by a command from the display controller 58 (refer to FIG. 7) of the main body 110, the controller 72 of the operating unit 120 turns on the backlight of the operating panel 121 (Step S58) and displays the closed advertisement data on the display unit 1212 (Step S60).

It may be configured so that, for example, for a user who is an administrator with an user ID of “Admin001,” the closed advertisement data of the new model depending on the number of used copies illustrated in FIG. 15 is displayed, whereas for a general user with a user ID of “User001” who does not have management authority, a message from the administrator or information such as a company newsletter is displayed.

If the certain operation input is received from the operating panel 121 of the operating unit 120 by the user (Step S62), the controller 72 of the operating unit 120 switches the closed advertisement data to the operating screen of the MFP 100 to be displayed (Step S64).

The reading controller 82 of the reading device 130 sends an end request for the reading processing to the reading unit 80 with the fact that the main body 110 has been shifted again (returned) to the energy-saving mode as a trigger (Step S66). The reading unit 80 that has received the end request ends the reading processing (Step S68).

In contrast, if the received authentication result indicates that the user authentication has been failed, the authentication managing unit 74 notifies the controller 72 of the operating unit 120 of the fact (Step S70). If the user authentication has been failed, by a command from the display controller 58 (refer to FIG. 7) of the main body 110, the controller 72 of the operating unit 120 turns on the backlight of the operating panel 121 (Step S72) and displays an error message on the display unit 1212 (Step S74). After a lapse of a certain time, the controller 72 turns off the backlight of the operating panel 121 (Step S76).

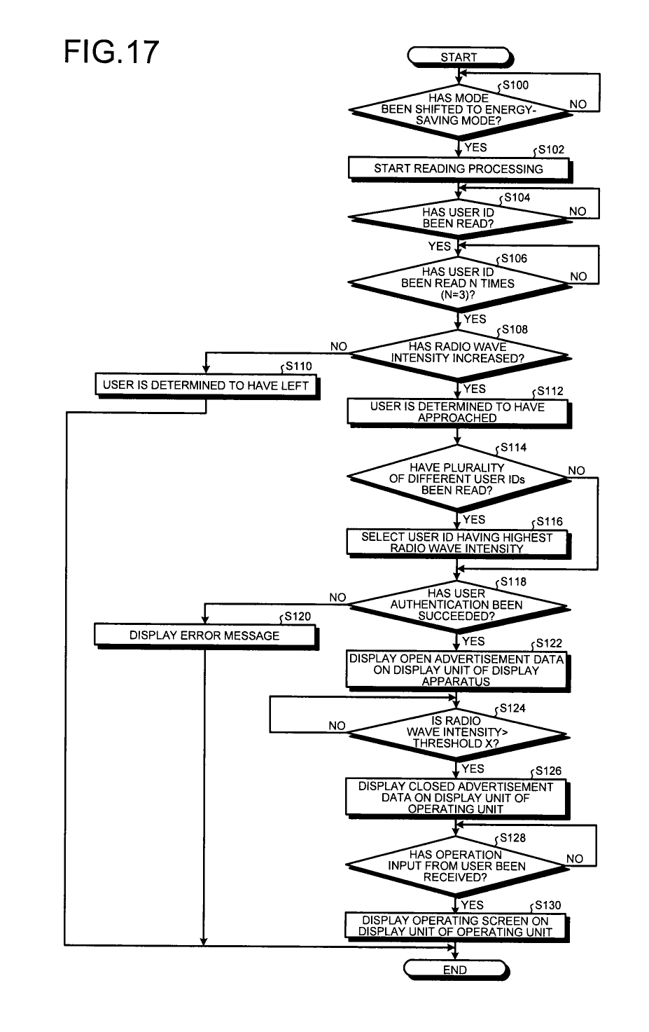

The following describes a procedure of the advertisement display processing in the MFP 100. FIG. 17 is a flowchart illustrating the procedure of the advertisement display processing in the MFP according to the embodiment.

First, the reading controller 82 determines whether or not the MFP 100 has been shifted to the energy-saving mode by the power supply controller 50 (Step S100). If the MFP 100 has not been shifted to the energy-saving mode (No at Step S100), the reading controller 82 waits until the mode is shifted to the energy-saving mode.

In contrast, if the MFP 100 has been shifted to the energy-saving mode (Yes at Step S100), the reading controller 82 starts the reading processing by the reading unit 80 (Step S102). The reading controller 82 determines whether or not the user ID has been read from the RFID tag 140 possessed by the user (Step S104). If the user ID has not been read (No at Step S104), the reading controller 82 waits until the user ID is read.

In contrast, if the user ID has been read (Yes at Step S104), the reading controller 82 transmits the user ID to the main body 110 via the communication unit 84 together with the radio wave intensity emitted when the user ID is read. The determining unit 56 determines whether or not the user ID has been read preset N times (Step S106). The number of reading N can be freely set, and in FIG. 17, it is determined whether or not the user ID has been read three times (N=3).

If the user ID has not been read three times (No at Step S106), the reading processing is continued until the user ID is read three times. In contrast, if the user ID has been read three times (Yes at Step S106), the determining unit 56 determines whether or not the radio wave intensity emitted when the user ID is read is increasing (Step S108). If the radio wave intensity is not increasing (No at Step S108), that is, it is attenuating, the determining unit 56 determines that the user has left the MFP 100 (Step S110) to end the processing.

In contrast, if the radio wave intensity is increasing (Yes at Step S108), the determining unit 56 determines that the user has approached the MFP 100 (Step S112). The determining unit 56 then determines whether or not a plurality of different user IDs have been read (Step S114). If the different user IDs have not been read (No at Step S114), that is, only the same user ID has been read, the read user ID is selected, and the processing at Step S118 is performed.

In contrast, if the different user IDs have been read (Yes at Step S114), the user ID having the highest radio wave intensity is selected (Step S116). The authenticating unit 54 then authenticates the user by the selected user ID. The display controller 58 determines whether or not the user authentication has been succeeded (Step S118), and if the user authentication has been failed (No at Step S118), the display controller 58 displays the error message on the display unit 1212 of the operating unit 120 (Step S120).

In contrast, if the user authentication has been succeeded (Yes at Step S118), the display controller 58 displays the open advertisement data for which the user who has succeeded in the user authentication has browsing authority on the display unit 90 of the display apparatus 150 (Step S122). The determining unit 56 determines whether or not the radio wave intensity emitted by the RFID tag 140 when the user ID is read exceeds the preset threshold (X) (Step S124). If the radio wave intensity does not exceed the threshold (X) (No at Step S124), the determining unit 56 waits until the radio wave intensity exceeds the threshold (X).

If the radio wave intensity exceeds the threshold (X) (Yes at Step S124), the display controller 58 determines that the user has come to the immediate front of the MFP 100 and displays the closed advertisement data for which the user who has succeeded in the user authentication has browsing authority on the display unit 1212 of the operating unit 120 (Step S126).

The display controller 58 then determines whether or not the certain operation input from the user has been received by the operating panel 121 of the operating unit 120 (Step S128). If the certain operation input from the user has not been received (No at Step S128), the display controller 58 waits until the certain operation input from the user is received. In contrast, if the certain operation input from the user has been received (Yes at Step S128), the display controller 58 displays the operating screen of the MFP 100 on the display unit 1212 of the operating unit 120 (Step S130).

Although the MFP 100 of the present embodiment displays the open advertisement data on the display apparatus 150 having the external large screen and displays the closed advertisement data on the operating unit 120, the external screen such as the display apparatus 150 may not be separately included. In other words, when no external screen is connected, displayed advertisement data may be switched in accordance with the distance (radio wave intensity) between the user and the MFP 100 using only the display unit 1212 of the operating unit 120. Specifically, when the radio wave intensity emitted by the RFID tag 140 is the threshold X or less, the open advertisement data is displayed on the display unit 1212, whereas when the radio wave intensity is the threshold X or more, the open advertisement data is switched to the closed advertisement data to be displayed.

Thus, the information processing system according to the present embodiment authenticates the user by the user ID read from the storage medium such as the RFID tag 140 possessed by the user. When the user authentication has been succeeded, the publicly-available open advertisement data for which the user who has succeeded in the user authentication has browsing authority among the advertisement data received from the content server 500 is displayed on the display unit 90 of the display apparatus 150 having the large screen externally attached to the MFP 100. When the user comes to the immediate front of the MFP 100, the closed advertisement data available only to the specific users including the user who has succeeded in the user authentication among the advertisement data received from the content server 500 is displayed on the display unit 1212 of the operating unit 120 at hand. Even when the closed advertisement data is displayed, if the certain operation input by the user is received from the user, the closed advertisement data is switched to the operating screen to be displayed. Consequently, the closed advertisement data (display information) containing the personal information for the user who uses the MFP 100 can be displayed without inhibiting the operation on the MFP 100 by the user and without being seen by irrelevant third parties.

An information processing program executed by the MFP 100 of the embodiment may be embedded and provided in a ROM, for example. The information processing program executed by the MFP 100 of the embodiment may be recorded and provided in a computer-readable recording medium such as a CD-ROM, a flexible disk (FD), a CD-R, and a digital versatile disc (DVD), as an installable or executable file.

The information processing program executed by the MFP 100 of the embodiment may be stored in a computer connected to a network such as the Internet and provided by being downloaded via the network. Furthermore, the information processing program executed by the MFP 100 of the embodiment may be provided or distributed via a network such as the Internet.

The information processing program executed by the MFP 100 of the embodiment has a module structure containing the above described units, and as actual hardware, a CPU (processor) reads the information processing program from the ROM and executes it, thereby loading the units onto a main memory and generating the units on the main memory. For example, part or whole of the functions of the units may be implemented by exclusive hardware circuits.

This embodiment does not limit the scope of the present invention, and the content server may include function to authenticate a user by a user ID, function to determine radio wave intensity emitted by an RFID tag, or the like. A plurality of managing apparatuses and information processing apparatuses may constitute the system, in which any apparatus may include any function. It is understood that the configuration of the information processing system in which the MFP as the information processing apparatus and the content server as the managing apparatus are connected described in the present embodiment is an example and that various system configuration examples can be achieved in accordance with applications or purposes.

Although the present embodiment describes the information processing apparatus of the present invention in detail by citing an example in which the information processing apparatus is applied to the multifunction peripheral (MFP), the information processing apparatus of the present invention can be applied to any apparatus that includes a display unit and can display information such as a copying machine, a printer, a projector, a scanner apparatus, and a facsimile apparatus.

The embodiments of present invention produce the advantageous effect of displaying display information containing personal information for a user who uses the apparatus without being seen by third parties.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus connected to a managing apparatus that manages display information via a network, the information processing apparatus comprising:
a communication unit that transmits apparatus identification information that identifies the information processing apparatus and apparatus information of the information processing apparatus to the managing apparatus and receives the display information corresponding to the apparatus identification information and the apparatus information from the managing apparatus;
a reading unit that reads user identification information that identifies a user from a storage medium;
an authenticating unit that authenticates a user by the read user identification information;
a display controller that, when the user is authenticated, displays publicly-available first display information among the received display information on a display unit; and
a determining unit that determines whether or not the storage medium is within a certain distance, wherein
the display controller, when the storage medium is determined to be present within the certain distance, displays, on the display unit, second display information available to a specific user including an authenticated user among the received display information.

2. The information processing apparatus according to claim 1, wherein
the determining unit determines whether or not the storage medium is within the certain distance by whether or not radio wave intensity emitted when the user identification information is read exceeds a preset threshold, and
the display controller, when the radio wave intensity is determined to have exceeded the threshold, displays the second display information on the display unit.

3. The information processing apparatus according to claim 2, wherein
the determining unit, when different pieces of user identification information have been read, selects the user identification information read from the storage medium that has emitted the highest radio wave intensity, and
the authenticating unit authenticates a user by the selected user identification information.

4. The information processing apparatus according to claim 2, wherein
the reading unit reads same user identification information a plurality of times,
the determining unit, when the radio wave intensity emitted when the same user identification information has been read a plurality of times is increasing, determines that a user has approached, and
the authenticating unit, when a user is determined to have approached, authenticates the user.

5. The information processing apparatus according to claim 1, wherein
the display unit includes a first display unit connected to a main body of the information processing apparatus and a second display unit provided for an operating unit of the information processing apparatus, and
the display controller displays the first display information on the first display unit and displays the second display information on the second display unit.

6. The information processing apparatus according to claim 5, wherein
the operating unit further includes a receiving unit that receives operation input from a user, and
the display controller, when a certain operation input is received from the receiving unit with the second display information displayed, switches the second display information displayed on the second display unit to an operating screen to be displayed for performing operation input to the information processing apparatus.

7. A method for processing information executed by an information processing apparatus connected to a managing apparatus that manages display information via a network, the method comprising:
communicating for transmitting apparatus identification information that identifies the information processing apparatus and apparatus information of the information processing apparatus to the managing apparatus and receiving the display information corresponding to the apparatus identification information and the apparatus information from the managing apparatus;
reading user identification information that identifies a user from a storage medium;
authenticating a user by the read user identification information;
first display controlling for, when the user is authenticated, displaying publicly-available first display information among the received display information on a display unit;
determining whether or not the storage medium is within a certain distance; and
second display controlling for, when the storage medium is determined to be present within the certain distance, displaying, on the display unit, second display information available to a specific user including an authenticated user among the received display information.

8. An information processing system comprising a managing apparatus that manages display information and an information processing apparatus connected via a network, the information processing system comprising:
a storage unit that stores therein apparatus identification information that identifies the information processing apparatus and apparatus information of the information processing apparatus in association with the display information;
a reading unit that reads user identification information that identifies a user from a storage medium;
an authenticating unit that authenticates a user by the read user identification information;
a display controller that, when the user is authenticated, displays, on a display unit, publicly-available first display information among the received display information; and
a determining unit that determines whether or not the storage medium is within a certain distance,
the display controller, when the storage medium is determined to be present within the certain distance, displaying, on the display unit, second display information available to a specific user including an authenticated user among the received display information.
